(19) United States
(12) Patent Application Publication
(10) Pub. No.: US 2019/0057474 A1
(43) Pub. Date: Feb. 21, 2019

(54) SYSTEM AND METHOD FOR FILTERING SENSOR DATA ASSOCIATED WITH AN AIR TRANSPORT PROCEDURE

(71) Applicant: Sikorsky Aircraft Corporation, Stratford, CT (US)

(72) Inventor: Jesse J. Lesperance, Harvest, AL (US)

(73) Assignee: Sikorsky Aircraft Corporation, Stratford, CT (US)

(21) Appl. No.: 15/761,985

(22) PCT Filed: Sep. 20, 2016
(86) PCT No.: PCT/US16/52588

§ 371 Date: Mar. 21, 2018

Related U.S. Application Data
(60) Provisional application No. 62/232,230, filed on Sep. 24, 2015.

(51) Int. Cl. G06Q 50/28; G01D 9/00

(52) U.S. Cl. CPC G06Q 50/28; G01D 9/00

(57) ABSTRACT

A computer system and method is provided to filter clearance sensor data output by a sensor system during a load/offload procedure of a first object relative to a second object. A processing device of the computer system is configured to access hard threshold data, unique threshold data, and sensor data output by the sensor system sensing aspects of the load/offload procedure. The processing device is further configured to determine whether the sensor data exceeds the unique threshold, determine whether the sensor data that is determined to exceed the unique threshold is voidable data related to a non-critical event, and generate filtered sensor data that includes modifications to the voidable data.

### CROSS REFERENCE TO RELATED APPLICATIONS

The subject invention claims the benefit of and priority to U.S. Provisional Application Ser. No. 62/232,230 filed Sep. 24, 2015, the disclosure of which is herein incorporated by reference in its entirety.

### FIELD OF THE INVENTION

The disclosed embodiments generally relate to a system and method for monitoring an air transport procedure, and more particularly to filtering sensor data associated with an air transport on and off-loading procedure.

### BACKGROUND OF THE INVENTION

Objects, such as vehicles (e.g., helicopters, trucks, tanks) are transported at times by another object, such as to a remote location. During an air transport procedure, a first object is loaded onto or offloaded from a second object. Sufficient clearance between the first and second object is needed at all times during the load/offload process. Legacy air transport practices rely heavily on interpretation of human experience judgment. The load/offload procedures are monitored visually, which can result in repetition of tasks, and sub-optimal load/offload procedures. Clearance sensors used to monitor the clearance between the first and second object can generate false alarms when a clearance threshold is sensed to be exceeded. The false alarms can halt the clearance procedure and cause delays.

While conventional methods and systems for air transport and load/offload procedures have generally been considered satisfactory for their intended purpose, there is still a need in the art for utilizing sensor data to solve problems associated with safety and efficiency during air transport and load/offload procedures. The present disclosure provides a solution for these problems.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, disclosed is a computer system and method to filter clearance sensor data output by the sensor system sensing aspects of the load/offload procedure. The computer system includes a processing device configured to access hard threshold data, unique threshold data, and sensor data output by the sensor system sensing aspects of the load/offload procedure. The computer system is further configured to determine whether the sensor data exceeds the unique threshold, determine whether the sensor data that is determined to exceed the unique threshold is voidable data related to a noncritical event, and generate filtered sensor data that includes modifications to the voidable data.

In embodiments, the sensor data can be accessed from a plurality of sensors of the sensor system, and a determination whether the sensor data is voidable data can include comparing sensor data output by one sensor of the plurality of sensors to data output by at least one other sensor of the plurality of sensors. The voidable data is modified to not exceed the unique threshold. The processing device can be further configured to access hard threshold data, determine whether the sensor data exceeds the hard threshold, and determine that sensor data which exceeds the hard threshold is not voidable data.

Additionally, in embodiments, the sensor data can be determined to be voidable data based on a period during which the sensor data exceeds the unique threshold data, an amount by which the sensor data exceeds the corresponding unique threshold data, and a rate of capture of the sensor data. The processing device can be further configured to access nominal data that indicates ideal sensor system outputs generated using a model, and the unique threshold data is determined based on the nominal data. The unique threshold data can be determined based on the hard threshold data.

Furthermore, in embodiments, the processing device can be further configured to generate predicted sensor data that can indicate predictions for future sensor system output as the movement of the first object relative to the second object progresses. The predicted sensor data can be generated based on the nominal data, the filtered sensor data and the unique threshold data. The predicted sensor data can be based on a trending profile determined from the nominal data and the filtered sensor data.

In embodiments, the processing device can be configured to determine the predicted sensor data in real time. Additionally, the sensor data can correspond to discrete time intervals or position intervals based on a position determined for the first object.

### BRIEF DESCRIPTION OF THE DRAWINGS

The accompanying appendices and/or drawings illustrate various non-limiting, example, inventive aspects in accordance with the present disclosure;

FIG. 1 illustrates a block diagram of an air transport clearance sensor data filtering system;

FIG. 2 illustrates a plot of sensor data accessed and processed by the sensor data filtering illustrated in FIG. 1;

FIG. 3 illustrates a flowchart illustrating a method for filtering sensor data that is performed by the sensor data filtering system illustrated in FIG. 1;

FIG. 4 illustrates an enlarged view of a portion of the plot of sensor data that is associated with a first event;

FIG. 5 illustrates an enlarged view of a portion of the plot of sensor data that is associated with a second event; and

FIG. 6 illustrates a computer system used to implement the sensor data filtering system illustrated in FIG. 1.

### DETAILED DESCRIPTION OF CERTAIN EMBODIMENTS

The present disclosure provides a system for filtering anomalies from sensor data and modifying the filtered sensor data so that the sensor data is useful despite the anomalies. The system dynamically generates local predicted data for multiple data sets. The filtered sensor data and predicted data can be output for display to a user and/or to other components of the system for further processing to provide recommendations or automatic control.

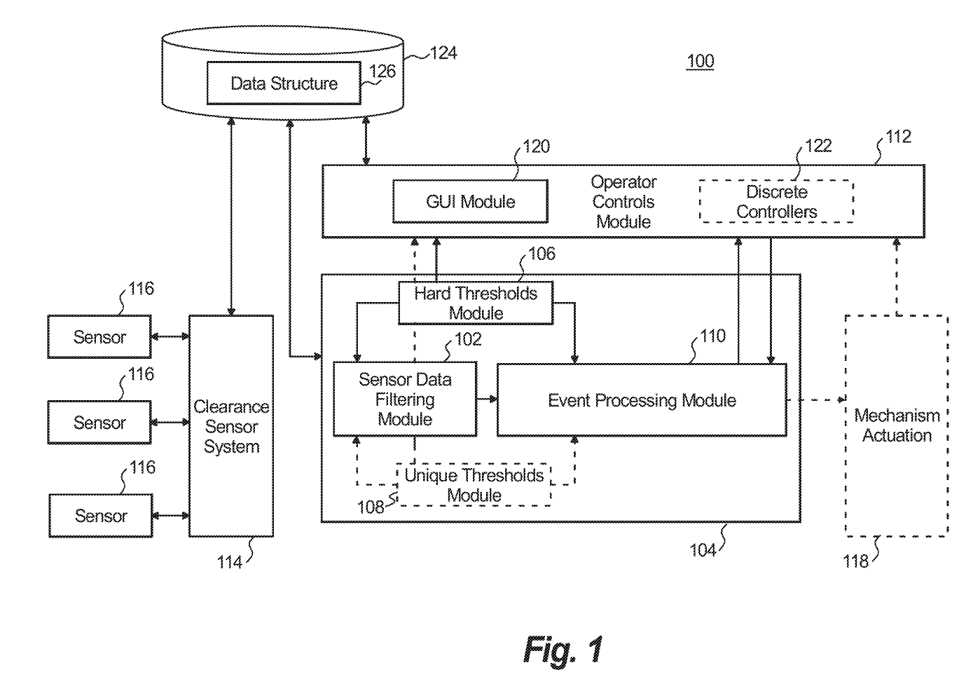

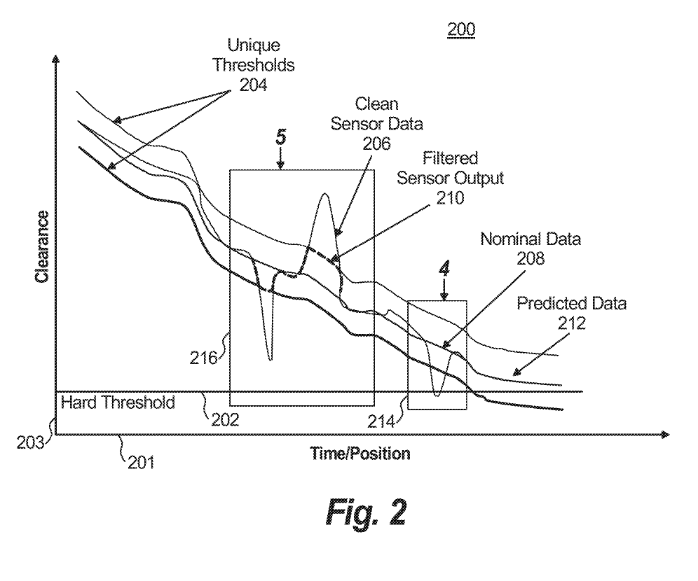

Reference will now be made to the drawings wherein like reference numerals identify similar structural features or aspects of the subject disclosure. For purposes of explanation and illustration, and not limitation, a block diagram of an exemplary embodiment of a system for filtering sensor data associated with air transport clearance in accordance with the disclosure is shown in FIG. 1 and is designated generally by reference character 100. Other embodiments of the air transport clearance sensor data filtering system in accordance with the disclosure, or aspects thereof, are provided in FIGS. 2-6, as will be described. The systems and methods described herein can be used to provide improved sensor data filtering and sensor data predicting in connection with loading and offloading clearance, for example in aerospace applications.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this disclosure as discussed below are implemented using a software algorithm, program, or code that can reside on a computer useable medium for enabling execution on a machine having a computer processor. The machine can include memory storage configured to provide output from execution of the computer algorithm or program.

As used herein, the term “software” is meant to be synonymous with any logic, code, or program that can be executed by a processor of a host computer, regardless of whether the implementation is in hardware, firmware or as a software computer product available on a disc, a memory storage device, or for download from a remote machine. The embodiments described herein include such software to implement the equations, relationships, and algorithms described above. One skilled in the art will appreciate further features and advantages of the disclosure based on the above-described embodiments. Accordingly, the disclosure is not to be limited by what has been particularly shown and described, except as indicated by the appended claims.

Description of certain illustrated embodiments of the present disclosure will now be provided. With reference now to FIG. 1, an exemplary air transport clearance sensor data filtering system 100 is generally shown in which a sensor data filter module 102 of a sensor data processing system 104 accesses cleaned sensor data. The sensor data processing system 104 further includes a hard thresholds module 106, a unique thresholds module 108, and an event processing module 110. The sensor data filtering module 102 accesses the hard threshold data provided by the hard thresholds module 106 and unique threshold data provided by the unique threshold data 108. Data output by the sensor data filtering module 102 is accessed by the event processing module 110 and/or the operator controls module 112.

The term “access” with reference to data, as used herein, refers to any combination of one or more of receiving, retrieving, reading, copying, viewing, or the like. An access can be direct or indirect. An example of a direct access is receiving data from a module that transmitted the data. An example of an indirect access from a module is retrieving a copy of data that is stored in a data structure, wherein the module generated the data or accessed the data from a data source, and stored a copy of the data in the data structure.

Output from the event processing module 110 can be accessed by the operator controls module 112 and/or a mechanism actuation module 118. The operator controls module 112 can include a graphical user interface (GUI) module 120 and/or discrete controllers 122 that control one or more aspects of a load or offload procedure. The GUI module 120 can present data via a display device, such as hard threshold data, unique threshold data, and event-related, data output by the event processing module 110. The mechanism actuation module 118 can include mechanical actuators that are controlled by control signals output by the event processing module 110.

A data storage medium 124 can be provided that stores a data structure 126. Data accessed by or accessible from modules 104, 106, 108, 110, 112, and 114 can be stored in the data structure 126 and accessed from the data structure 126. Some of the data that is stored in the data structure 126, such as hard threshold data, is predetermined data that can be stored before a load/offload procedure. For example, hard threshold data can be predetermined to comply with government regulation. Other data stored in the data structure 126 can be dynamically generated or updated during the load/offload procedure, such as in real time, wherein “real time” includes “near real-time” or “nearly real-time” (NRT), which refers to timing that includes a time delay introduced by automated data processing or data transmission that transpires between the occurrence of an event and the use of the processed data, such as for display, further processing, feedback, or control purposes.

Accordingly, hard threshold data, unique threshold data, clean sensor data, filtered sensor data, nominal data (described further below), and predicted data that are accessed by or from the sensor data filtering module 102 can be stored in the data structure 126 and accessed directly from the data structure 126 by the sensor data filtering module 102, the event processing module 110, and/or the operator controls module 112.

The data storage medium 124 is a volatile or nonvolatile storage device that can be local to or remote from the sensor data filtering module 102. In an embodiment, the sensor data filtering module 102 is a magnetic storage device that is remote from the sensor data processing system 104. The data structure 126 can be a table or other data structure that stores hard threshold data, unique threshold data, nominal data, clean sensor data, filtered sensor data, and/or predicted data relative to time and/or position of the first object while being guided relative to a second object during a load or offload procedure. Data structure 126 can be updated in real time as a load or offload procedure is occurring.

FIG. 2 shows a plot 200 of data accessed and generated by the sensor data filtering module 102. The x-axis can indicate time, or alternatively, position of a first object that is being loaded or off-loaded relative to a second object. The y-axis can indicate a clearance distance between the first and second objects. The clean sensor data can correspond to sensor output by one or more sensors of a sensor system at discrete times or discrete positions of the first object. The sensor data output by a sensor can include attributes, meta data and associated data, that describe characteristics, such as identification (ID) of the sensor, sensor configuration, sensor orientation (e.g., degrees, radius), measurement reference plane, operator generated notes, data type, calibration file, angle of incidence, etc. The first and second objects can both be vehicles, such as aircraft, trucks, or tanks, but are not limited thereto.

The sensor data filtering module 102 accesses hard threshold data shown as hard threshold data plot 202, unique threshold data shown as unique threshold data plot 204, and clean sensor data, shown as clean sensor data plot 206. The hard threshold data is predetermined data that sets a hard threshold for clearance between first and second objects undergoing a load/offload procedure. The hard threshold data can be inner-limit data, which can be static or dynamic throughout the load/offload procedure. The hard threshold data can be determined by a first entity, such as a governing body, e.g., a government agency, an insurance/liability company, or the like. For example, the hard threshold data can define a 2″ clearance to be maintained between the first and second objects at all times.

The unique threshold data can be outer-limit data that sets a tighter threshold than the hard threshold, to guard from reaching the hard threshold which is determined by the sensor data filtering module 102 or another module. The unique threshold data can be static or dynamic during the load/offload procedure. Static unique threshold data can be set at a fixed interval from the hard threshold data. For example, if the hard threshold data requires a 2″ clearance at all times between the first and second objects, the unique threshold data can be set for an additional 4″ clearance, i.e., so that the unique threshold data defines a 6″ clearance between the first and second objects.

Dynamic unique threshold data can be determined based on nominal data described by a nominal data plot 208 that can be derived from an optimal model. The nominal data defines an ideal clearance between the first and second objects during the load/offload procedure. In an embodiment, the unique threshold is determined in real-time to reflect changes in the nominal data that may occur in real-time.

The nominal data can be determined by the sensor data filtering module 102, or another module, such as by using 3-dimensional modeling for the load/offload procedure. The nominal data can describe an ideal clearance amount as the load/offload procedure progresses. In an embodiment, the nominal data is determined in real-time as the load/offload procedure is progressing, and accounts for changes that may affect the clearance targets for the load/offload procedure.

The clean sensor data can be generated by the clearance sensor system 114. The sensor data filtering module 102 can access the clean sensor data directly from the clearance sensor system 114 or from the data structure 126. The clearance sensor system 114 can access and clean data output by a plurality of clearance sensors 116 during a load/offload procedure, such as position sensors, load sensors, motion sensors, etc. that sense movement of a first object being guided relative to a second object. The cleaning performed by the clearance sensor system 114 can include removing errors from the data output by the clearance sensors. The sensor data filtering module 102 processes the clean sensor data based on the hard threshold data and unique threshold data (which can be based on the nominal data) and generates a filtered sensor data plot 210 indicating filtered sensor data and/or a predicted data plot 212 indicating predicted data. The filtered sensor data and predicted data can be output in real-time or after the load/offload procedure for analysis. The filtered sensor data and predicted data can be provided to the operator controls 112 for display and/or to the event processing module 110 for additional processing that can output displayable information and/or control signals.

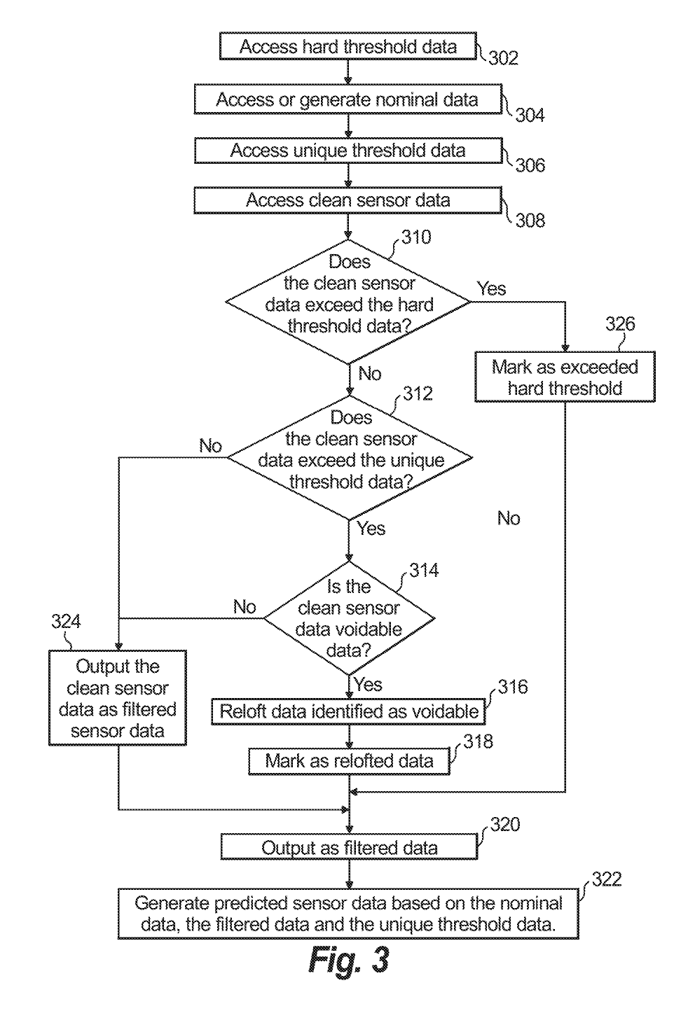

FIG. 3 is a flowchart of operational steps of the sensor data filtering module 102 of FIG. 1 for processing of the clean sensor data, in accordance with exemplary embodiments of the present disclosure. Before turning to description of FIG. 3, it is noted that the flow diagram in FIG. 3 shows an example in which operational steps are carried out in a particular order, as indicated by the lines connecting the blocks, but the various steps shown in this diagram can be performed in any order, or in any combination or sub-combination. It should be appreciated that in some embodiments some of the steps described below may be combined into a single step. In some embodiments, one or more additional steps may be included. The operational steps can be performed as a real-time loop or a near real-time loop.

At operation 302, hard threshold data is accessed, such as from data structure 126. At operation 304 (which is an optional operation), nominal data is generated or accessed, such as from data structure 126. At operation 306, unique threshold data is generated or accessed, such as from data structure 126. The unique threshold data can be determined based on the hard threshold data, or based on the nominal data. At operation 308, the clean sensor data is accessed.

At operation 310 a determination is made whether the clean sensor data exceeds the hard threshold data. If the determination at operation 310 is YES then the data is marked as a hard threshold exceedance at 326. If the determination at operation 310 is NO, at operation 312, a determination is made whether the clean sensor data exceeds the unique threshold data. The unique threshold data can include an upper limit threshold and a lower limit threshold. Exceeding the unique threshold data can include being higher than the upper limit threshold or lower than the lower limit threshold. If the determination at operation 312 is NO then the clean sensor data is output as filtered sensor data at 324.

If the determination at operation 312 is YES, at operation 314, a determination is made if the clean sensor data is voidable data. Determining and identifying voidable data in the clean sensor data includes determining whether the exceedance of the unique threshold data corresponds to a percent rate of change.

When performed in real time or near real time, the clean sensor data is monitored for a voidable data that includes an anomaly, e.g., a drastic uncorrelated rate-of-change. The rate-of-change can be evaluated as a rolling percent rate-of-change. The voidable data is identified as a significant increase or decrease in a value of the sensor data that does not correlate with a reciprocating change in an opposing sensors direction. A large deviation in any one direction that correlates to un-voidable data associated with an actual event would be represented with a reciprocating change in an opposing sensor. If the reciprocating change is not present, the detected change is identified as a void. The void that exceeds the unique threshold is relofted.

The percent rate-of-change used to identify voidable data is dynamic and depends upon the capture rate of the clean sensor data and a period of change of the clean sensor data. Operation of the clearance sensor system can vary to include time triggered events at varying frequency, user selected trigger events, and/or distance triggered events. Each one of these operations poses a unique challenge for evaluating what is considered to be an “uncharacteristic” event that is an anomaly. For instance, the faster, or the closer together, the trigger events occur, can result in a lower tolerance of percent rate-of-change. The longer or further they are apart, the higher the tolerance of percent rate-of-change that can be tolerated. This tolerance can be dynamically adjusted based upon user control input. The determination of whether the clean sensor data is voidable depends on an indication that an anomaly caused the clean sensor data to exceed the unique threshold. The indication can be based on output from one or more other sensors that may or may not have been affected by the same anomaly. An example of an anomaly includes sensor blockage, e.g., caused by an object or person temporarily obstructing the sensing path of a sensor. Another example of an anomaly includes a void in the object being measured, e.g., caused by a gap or opening in the object that allows the sensing path of a sensor to pass through, These examples of an anomaly can be further identified when the clean sensor data should include reciprocating peaks in opposite directions, but does not. If the determination at operation 314 is NO then the clean sensor data is output as filtered sensor data at 324.

If the determination at operation 314 is YES, at operation 316, the data identified to be voidable is relofted. Relating the data includes replacing a portion of the clean sensor data that exceeds the unique threshold with the unique threshold that extends through the portion being replaced. At operation 318, the data that was relofted is stored as relofted data, which can include storing the relofted data in an area designated for relofted data, or associating an attribute, flag or meta data, etc., with the relofted data that indicates that the data was relofted.

At operation 320, the relofted data and clean sensor data is output, or is available to be accessed from the data structure 126. At operation 322 (which is an optional operation), predicted sensor data is generated. The predicted sensor data can be generated based on the nominal data, the filtered sensor data, and the unique threshold data. The predicted sensor data can correspond to a predetermined number of data points, a predetermined time interval, or a predetermined position, that extend into the future beyond the current time or position that corresponds to the most recently accessed clean sensor data. The predicted sensor data can further be determined based on a trending profile determined, from the nominal data and the filtered sensor data.

The sensor data filtering module 102 can access and process clean sensor data, hard threshold data, unique threshold data, and nominal data, for a plurality of different data sets at substantially the same time, and output corresponding filtered sensor data and predicted data in real time.

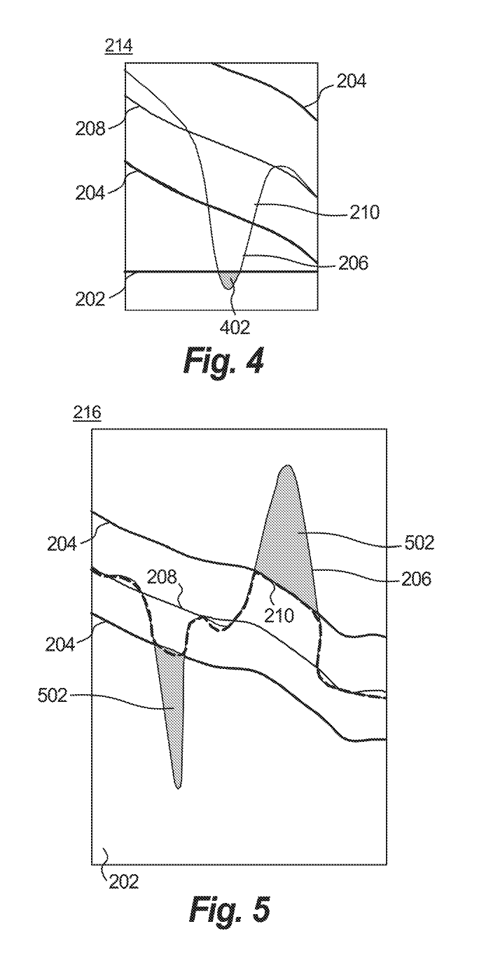

FIGS. 4 and 5 show portions 214 and 216 of the plot 200 that correspond to events in which thresholds were exceeded in FIG. 2. In FIG. 4, the hard threshold plot 202 was exceeded by the clean sensor data plot 206. Area 402 is an area defined by clean sensor data plot 206 and the hard threshold plot 202, wherein area 402 exceeds (here, lies below) the hard threshold plot 202. Exceedance of a hard threshold plot 202 can be a serious event that may be regulated by governing regulations. Accordingly, the clean sensor data that defines area 402 is stored with an indication that the clean sensor data was associated with a hard threshold exceedance. The clean sensor data associated with the hard threshold exceedance is incorporated into processing, can be accessed by the operator controls for visualization, and can be accessed by the event processing module 110.

In FIG. 5, the unique threshold plot 204 was exceeded by the clean sensor data 206. Areas 502 are defined by clean sensor data plot 206 and unique threshold plots 204, wherein areas 502 exceed (lies above the upper unique threshold plot 204 or below the lower unique threshold plot 204) the unique threshold plots 204. Exceedance of the unique threshold plots 204 can be due to an anomaly. When an anomaly is determined to be the cause of the exceedance, it is preferable to avoid including clean sensor data that is associated with the exceedance with information that is accessed by the operator controls for visualization and by the event processing module 110. Accordingly, the clean sensor data 206 is stored, but filtered sensor data is generated that does not exceed the unique data threshold. In an embodiment, clean sensor data that exceeds the unique threshold data is modified in the filtered sensor data to coincide with the unique threshold plots 204.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

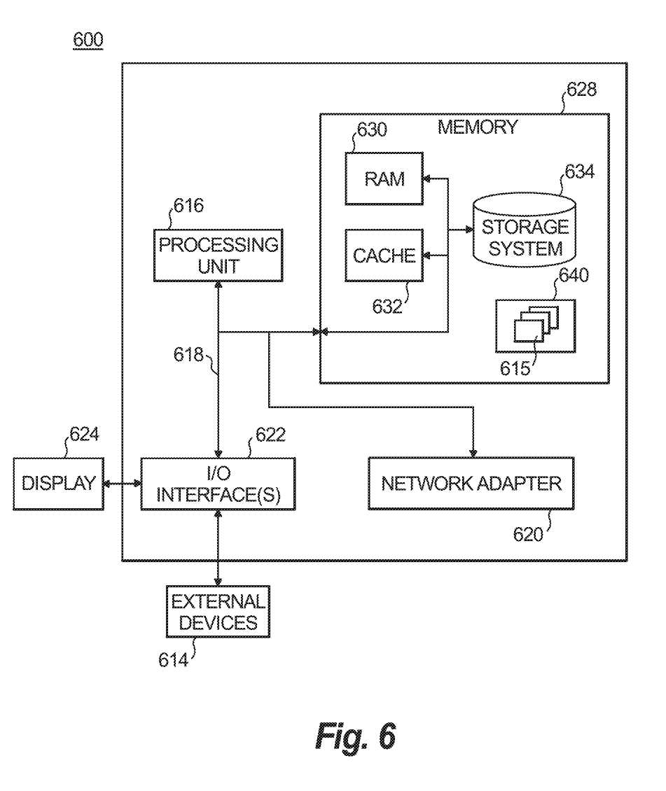

Embodiments of the method described above for filtering sensor data during an air transport load/offload procedure can be executed by the sensor data processing system 104 using one or more computer systems 600. One such computer system 600 is illustrated in FIG. 6. In various embodiments, computer system 600 may be a server, a mainframe computer system, a workstation, a network computer, a desktop computer, a laptop, or the like, and/or include one or more of a field-programmable gate array (FPGA), application specific integrated circuit (ASIC), microcontroller, microprocessor, or the like. The computer system 600, operator controls module 112, data storage medium 124, and/or clearance sensor system 114 can be incorporated into a processing system of one of the objects participating in the load/offload procedure, a standalone processing system, distributed processing system, and/or display controller system, The computer system 600, operator controls module 112, data storage medium 124, and/or clearance sensor system 114 can use independent power sources, use a common power distribution system, or a combination of both types of power provision.

Computer system 600 is only one example of a suitable system and is not intended to suggest any limitation as to the scope of use or functionality of embodiments of the disclosure described herein. Regardless, computer system 600 is capable of being implemented and/or performing any of the functionality set forth hereinabove.

Computer system 600 may be described in the general context of computer system-executable instructions, such as program modules, being executed by a computer system. Generally, program modules may include routines, programs, objects, components, logic, data structures, and so on that perform particular tasks or implement particular abstract data types. Computer system 600 may be practiced in distributed data processing environments where tasks are performed by remote processing devices that are linked through a communications network. In a distributed data processing environment, program modules may be located in both local and remote computer system storage media including memory storage devices.

Computer system 600 is shown in FIG. 6 in the form of a general-purpose computing device. The components of computer system 600 may include, but are not limited to, one or more processors or processing units 616, a system memory 628, and a bus 618 that couples various system components including system memory 628 to processor 616.

Bus 618 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 600 typically includes or accesses a variety of computer system readable media, such as data storage medium 124. Such media may be any available media. is accessible by computer system 600, and it includes both volatile and non-volatile media, removable and non-removable media.

System memory 628 can include computer system readable media in the form of volatile memory, such as random access memory (RAM) 630 and/or cache memory 632. Computer system 600 may further include other removable/non-removable, volatile/non-volatile computer system storage media. By way of example only, storage system 634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 618 by one or more data media interfaces. As will be further depicted and described below, memory 628 may include at least one program product having a set (e.g., at least one) of program modules that are configured to carry out the functions of embodiments of the disclosure.

Program/utility 640, having a set (at least one) of program modules 615, such as the method described by the operations of FIG. 3, may be stored in memory 628 by way of example, and not limitation, as well as an operating system, one or mare application programs, other program modules, and program data. Each of the operating system, one or more application programs, other program modules, and program data or some combination thereof, may include an implementation of a networking environment. Program modules 615 generally carry out the functions and/or methodologies of embodiments of the disclosure as described herein.

Computer system 600 may also communicate with one or more external devices 614 such as a keyboard, a pointing device, a display 624, etc.; one or more devices that enable a user to interact with computer system 600; and/or any devices (e.g., network card, modem, etc.) that enable the computer system 600 to communicate with one or more other computing devices. Such communication can occur via Input/Output (I/O) interfaces 622. Still yet, computer system 600 can communicate with one or more networks such as a local area network (LAN), a general wide area network (WAN), and/or a public network (e.g., the Internet) via network adapter 620. As depicted, network adapter 620 communicates with the other components of sensor data processing system 104 via bus 618. It should be understood that although not shown, other hardware and/or software components could be used in conjunction with computer system 600. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A potential advantage of the system and method disclosed for filtering sensor data by the sensor data filtering 102 computer system 600 is that quantitative real-time data monitoring can be analytically performed to reduce false indications to the operator and to provide reliable data and predicted models to the events processing module 110 of the sensor data filtering system 100.

The techniques described herein are exemplary, and should not be construed as implying any particular limitation of the certain illustrated embodiments. It should be understood that various alternatives, combinations, and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

Although the systems and methods of the subject disclosure have been described with respect to the embodiments disclosed above, those skilled in the art will readily appreciate that changes and modifications may be made thereto without departing from the spirit and scope of the certain illustrated embodiments as defined by the appended claims.

What is claimed is:

1. A computer system to filter clearance sensor data output by a sensor system during a load/offload procedure of a first object relative to a second object, the computer system comprising:
a processing device configured to:
access hard threshold data;
access unique threshold data;
access sensor data output by the sensor system sensing aspects of the load/offload procedure;
determine whether the sensor data exceeds the unique threshold;
determine whether the sensor data that is determined to exceed the unique threshold is voidable data related to a noncritical event; and
generate filtered sensor data that includes modifications to the voidable data.

2. The computer system of claim 1, wherein the sensor data is accessed from a plurality of sensors, and a determination whether the sensor data is voidable data includes comparing sensor data output by one sensor of the plurality of sensors to data output by at least one other sensor of the plurality of sensors.

3. The computer system of claim 1, wherein the voidable data is modified to not exceed the unique threshold.

4. The computer system of claim 1, wherein the processing device is further configured to:
determine whether the sensor data exceeds the hard threshold; and
determine that sensor data which exceeds the hard threshold is not voidable data.

5. The computer system of claim 1, wherein the sensor data is determined to be voidable data based on a period during which the sensor data exceeds the unique threshold data, an amount by which the sensor data exceeds the corresponding unique threshold data, and a rate of capture of the sensor data.

6. The computer system of claim 1, wherein the processing device is further configured to access nominal data that indicates ideal sensor system outputs generated using a model, and the unique threshold data is determined based on the nominal data.

7. The computer system of claim 1, wherein the unique threshold data is determined based on the hard threshold data.

8. The computer system of claim 1, wherein the processing device is further configured to generate predicted sensor data that indicates predictions for future sensor system output as the movement of the first object relative to the second object progresses, the predicted sensor data being generated based on the nominal data, the filtered sensor data and the unique threshold data.

9. The computer system of claim 8, wherein the processing device is further configured to determine the predicted sensor data based on a trending profile determined from the nominal data and the filtered sensor data.

10. The computer system of claim 8, wherein the processing device is further configured to determine the predicted sensor data in real time.

11. The computer system of claim 1, wherein the sensor data corresponds to discrete time intervals or position intervals based on a position determined for the first object.

12. A method to filter clearance sensor data output by a sensor system during a load/offload procedure of a first object relative to a second object, the method comprising:
accessing hard threshold data;
accessing unique threshold data;
accessing sensor data associated with aspects of the load/offload procedure; determining whether the sensor data exceeds the unique threshold;
determining whether the sensor data that is determined to exceed the unique threshold is voidable data related to a noncritical event; and
generating filtered sensor data that includes modifications to the voidable data.

13. The method of claim 12, further comprising:
determining whether the sensor data exceeds the hard threshold; and
determining that sensor data that exceeds the hard threshold is not voidable data.

14. The method of claim 12, further comprising accessing nominal data that indicates ideal sensor system outputs generated using a model, wherein the unique threshold data is determined based on the nominal data.

15. The method of claim 14, further comprising generating predicted sensor data that indicates predictions for future sensor system output as the movement of the first object relative to the second object progresses, the predicted sensor data being generated based on the nominal data, the filtered sensor data and the unique threshold data.
